(19) United States
(12) Patent Application Publication
(10) Pub. No.: US 2023/0135982 A1
(43) Pub. Date: May 4, 2023

(54) ELECTROCHEMICAL CELL DEVICE

(71) Applicant: SUMITOMO ELECTRIC INDUSTRIES, LTD., Osaka-shi, Osaka (JP)

(72) Inventors: Koma NUMATA, Osaka-shi (JP); Masatoshi MAJIMA, Osaka-shi (JP); Mitsuyasu OGAWA, Osaka-shi (JP); Naho MIZUHARA, Osaka-shi (JP); Yohei NODA, Osaka-shi (JP)

(73) Assignee: SUMITOMO ELECTRIC INDUSTRIES, LTD., Osaka-shi, Osaka (JP)

(21) Appl. No.: 17/914,801

(22) PCT Filed: Jan. 19, 2021
(86) PCT No.: PCT/JP2021/001578

§ 371 Date: Sep. 27, 2022

(30) Foreign Application Priority Data
Apr. 15, 2020 (JP) 2020-072919

(51) Int. Cl. H01M 4/86

(52) U.S. Cl. CPC H01M 4/8621; H01M 2008/1293

(57) ABSTRACT

A electrochemical cell device includes: a cell having a first main surface and a second main surface opposite to the first main surface; a first current collector having a third main surface facing the first main surface; and a second current collector having a fourth main surface facing the second main surface. The cell is warped to protrude from the second main surface toward the first main surface. The third main surface is provided with a recess at a position facing a central portion of the first main surface. The fourth main surface includes a protrusion at a position facing a central portion of the second main surface. Each of the first current collector and the second current collector is constituted of one or more metal porous body sheets each composed of a metal porous body having a framework with a three-dimensional network structure.

### TECHNICAL FIELD

The present disclosure relates to an electrochemical cell device. The present application claims a priority based on Japanese Patent Application No. 2020-072919 filed on Apr. 15, 2020, the entire content of which is incorporated herein by reference.

### BACKGROUND ART

PTL 1 (WO 2019/244480) describes a fuel cell. The fuel cell described in PTL 1 includes a solid electrolyte layer, an anode, a cathode, an anode side current collector, and a cathode side current collector.

The anode and the cathode sandwich the solid electrolyte layer (hereinafter, the solid electrolyte layer sandwiched between the anode and the cathode will be referred to as “cell”). The anode side current collector and the cathode side current collector sandwich the cell. Each of the anode side current collector and the cathode side current collector is constituted of a metal porous body sheet composed of a metal porous body having a framework with a three-dimensional network structure.

### CITATION LIST

### Patent Literature

PTL 1: WO 2019/244480

### SUMMARY OF INVENTION

An electrochemical cell device according to the present disclosure includes: a cell having a first main surface and a second main surface opposite to the first main surface; a first current collector having a third main surface facing the first main surface; and a second current collector having a fourth main surface facing the second main surface. The cell is warped to protrude from the second main surface toward the first main surface. The third main surface is provided with a recess at a position facing a central portion of the first main surface. The fourth main surface includes a protrusion at a position facing a central portion of the second main surface. Each of the first current collector and the second current collector is constituted of one or more metal porous body sheets each composed of a metal porous body having a framework with a three-dimensional network structure. The central portion of the first main surface includes a portion of the first main surface with a longest distance from a flat reference surface when the cell is placed on the reference surface such that the second main surface faces the reference surface. The central portion of the second main surface includes a portion of the second main surface with a longest distance from the reference surface when the cell is disposed on the reference surface such that the second main surface faces the reference surface.

### BRIEF DESCRIPTION OF DRAWINGS

FIG. 1A is a cross sectional view of an electrochemical cell device 100.

FIG. 1B is an enlarged cross sectional view of a cell 10.

FIG. 2 is a plan view of cell 10.

FIG. 3 is a schematic cross sectional view showing a shape of warpage of cell 10.

FIG. 4 is a plan view of a current collector 20.

FIG. 5 is a cross sectional view at V-V of FIG. 4.

FIG. 6 is a plan view of a current collector 30.

FIG. 7 is a cross sectional view at VII-VII of FIG. 6.

FIG. 8 is a plan view of a current collector 20 of an electrochemical cell device 200.

FIG. 9 is a cross sectional view at IX-IX of FIG. 8.

FIG. 10 is a plan view of a current collector 30 of electrochemical cell device 200.

FIG. 11 is a cross sectional view at XI-XI of FIG. 10.

FIG. 12 is a cross sectional view of a current collector 20 of an electrochemical cell device 300.

FIG. 13 is a cross sectional view of a current collector 30 of electrochemical cell device 300.

### DETAILED DESCRIPTION

### Problem to be Solved by the Present Disclosure

In the fuel cell according to PTL 1, a cell may be warped. When the cell is warped, spaces are formed between the cell and the anode side current collector and between the cell and the cathode side current collector (contact between the cell and each current collector is deteriorated).

The present disclosure provides an electrochemical cell device to reduce a space between a cell and a current collector.

### Advantageous Effect of the Present Disclosure

According to the electrochemical cell device of the present disclosure, the space between the cell and the current collector can be reduced.

### DESCRIPTION OF EMBODIMENTS

First, embodiments of the present disclosure are listed and described.

(1) An electrochemical cell device according to one embodiment includes: a cell having a first main surface and a second main surface opposite to the first main surface; a first current collector having a third main surface facing the first main surface; and a second current collector having a fourth main surface facing the second main surface. The cell is warped to protrude from the second main surface toward the first main surface. The third main surface is provided with a recess at a position facing a central portion of the first main surface. The fourth main surface includes a protrusion at a position facing a central portion of the second main surface. Each of the first current collector and the second current collector is constituted of one or more metal porous body sheets each composed of a metal porous body having a framework with a three-dimensional network structure. The central portion of the first main surface includes a portion of the first main surface with a longest distance from a flat reference surface when the cell is placed on the reference surface such that the second main surface faces the reference surface. The central portion of the second main surface includes a portion of the second main surface with a longest distance from the reference surface when the cell is disposed on the reference surface such that the second main surface faces the reference surface.

According to the electrochemical cell device of (1), a space between the cell and each current collector can be reduced.

(2) In the electrochemical cell device of (1), the one or more metal porous body sheets of the first current collector may be a first metal porous body sheet and a second metal porous body sheet. The first metal porous body sheet and the second metal porous body sheet may be disposed side by side in a plane orthogonal to a thickness direction of the first current collector. A first through hole may be formed in the second metal porous body sheet at a position corresponding to the recess so as to extend through the second metal porous body sheet in a thickness direction of the second metal porous body sheet. The first metal porous body sheet may be disposed in the first through hole. A thickness of the second metal porous body sheet may be more than a thickness of the first metal porous body sheet. The recess may be defined by an inner peripheral surface of the first through hole and a main surface of the first metal porous body sheet.

According to the electrochemical cell device of (2), the space between the cell and the current collector can be reduced.

(3) In the electrochemical cell device of (2), a value obtained by subtracting the thickness of the first metal porous body sheet from the thickness of the second metal porous body sheet may be equal to a warpage amount of the cell.

According to the electrochemical cell device of (3), the space between the cell and the current collector can be further reduced.

(4) In the electrochemical cell device of (1), the one or more metal porous body sheets of the first current collector may be a first metal porous body sheet and a second metal porous body sheet. The first metal porous body sheet and the second metal porous body sheet may be disposed to be stacked on each other such that the second metal porous body sheet is located on the third main surface side in a thickness direction of the first current collector. A first through hole may be formed in the second metal porous body sheet at a position corresponding to the recess so as to extend through the second metal porous body sheet in a thickness direction of the second metal porous body sheet.

(5) In the electrochemical cell device of any one of (1) to (4), the one or more metal porous body sheets of the second current collector may be a third metal porous body sheet and a fourth metal porous body sheet. The third metal porous body sheet and the fourth metal porous body sheet may be disposed side by side in a plane orthogonal to a thickness direction of the second current collector. A second through hole may be formed in the fourth metal porous body sheet at a position corresponding to the protrusion so as to extend through the fourth metal porous body sheet in a thickness direction of the fourth metal porous body sheet. The third metal porous body sheet may be disposed in the second through hole. A thickness of the third metal porous body sheet may be more than a thickness of the fourth metal porous body sheet.

According to the electrochemical cell device of (5), the space between the cell and the current collector can be reduced.

(6) In the electrochemical cell device of (1) to (4), a value obtained by subtracting the thickness of the fourth metal porous body sheet from the thickness of the third metal porous body sheet may be equal to a warpage amount of the cell.

According to the electrochemical cell device of (6), the space between the cell and the current collector can be further reduced.

(7) In the electrochemical cell device of any one of (1) to (4), the one or more metal porous body sheets of the second current collector may be a third metal porous body sheet and a fourth metal porous body sheet. The third metal porous body sheet and the fourth metal porous body sheet may be disposed to be stacked on each other such that the fourth metal porous body sheet is located on the fourth main surface side in a thickness direction of the second current collector. The fourth metal porous body sheet may constitute the protrusion.

According to the electrochemical cell device of (7), the space between the cell and the current collector can be reduced.

(8) In the electrochemical cell device of (1) to (7), the first current collector may be a cathode side current collector, and the second current collector may be an anode side current collector.

According to the electrochemical cell device of (8), the space between the cell and the current collector can be reduced.

(9) In the electrochemical cell device of (8), the framework of each of the one or more metal porous body sheets of the first current collector may contain nickel and cobalt. A coating weight of each of the one or more metal porous body sheets of the first current collector may be 900 g/m² or less.

According to the electrochemical cell device of (9), the space between the cell and the current collector can be reduced.

(10) In the electrochemical cell device of (8), the framework of each of the one or more metal porous body sheets of the second current collector may contain nickel. A coating weight of each of the one or more metal porous body sheets of the second current collector may be 1000 g/m² or less.

(11) In the electrochemical cell device according to (1) to (10), a value obtained by dividing a warpage amount of the cell by a maximum width of the cell when viewed in a plan view may be 1/1000 or more.

According to the electrochemical cell device of (11), even when the warpage of the cell is large, the space between the cell and the current collector can be reduced.

(12) The electrochemical cell device of (1) to (11) may be a solid oxide fuel cell.

According to the electrochemical cell device of (12), contact between the cell and the current collector can be improved, thus resulting in increased output voltage in the solid oxide fuel cell.

(13) The electrochemical cell device of (1) to (11) may be a solid oxide electrolysis cell.

According to the electrochemical cell device of (13), contact between the cell and the current collector can be improved, thus resulting in lowered electrolytic voltage in the solid oxide electrolysis cell.

### Details of Embodiments of the Present Disclosure

Next, embodiments of the present disclosure will be described with reference to figures. Here, the same or corresponding portions are denoted by the same reference characters, and the same explanation will not be described repeatedly.

### First Embodiment

Hereinafter, a configuration of an electrochemical cell device (hereinafter, referred to as “electrochemical cell device 100”) according to a first embodiment will be described.

Electrochemical cell device 100 is a solid oxide fuel cell (SOFC). Although electrochemical cell device 100 may be a solid oxide electrolysis cell (SOEC), the SOFC will be described below as an exemplary electrochemical cell device 100.

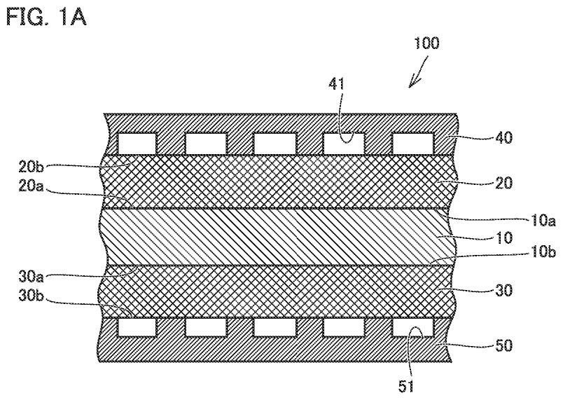

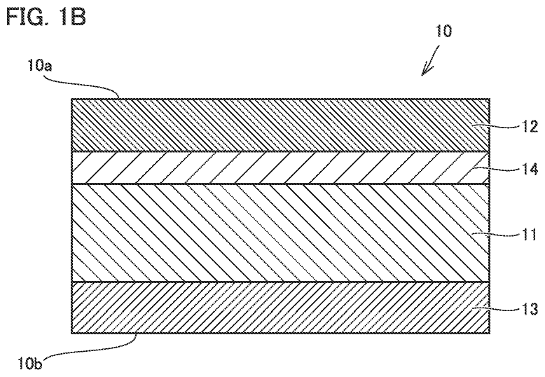

FIG. 1A is a cross sectional view of electrochemical cell device 100. FIG. 1A shows a structure of a single-cell included in electrochemical cell device 100. Electrochemical cell device 100 is formed by stacking a plurality of single-cell structures. Further, FIG. 1A does not illustrate warpage of a cell 10, a recess 20c, and a protrusion 30c, which will be described later. FIG. 1B is an enlarged cross sectional view of cell 10. As shown in FIGS. 1A and 1B, electrochemical cell device 100 includes cell 10, a current collector 20, a current collector 30, an interconnector 40, and an interconnector 50.

Cell 10 has a main surface 10a and a main surface 10b. Main surface 10b is a surface opposite to main surface 10a. Cell 10 includes a solid electrolyte layer 11, a cathode 12, an anode 13, and an intermediate layer 14.

Solid electrolyte layer 11 is a layer composed of a solid electrolyte. For example, solid electrolyte layer 11 is composed of an oxide (YSZ) of zirconium (Zr) doped with yttrium (Y). Cathode 12 is composed of, for example, LSC (oxide of lanthanum (La) strontium (Sr) cobalt (Co)). Anode 13 is composed of, for example, a mixture of YSZ and an oxide of nickel (Ni₂O). Intermediate layer 14 is composed of, for example, an oxide (GDC) of cerium (Ce) doped with gadolinium (Gd).

Cathode 12 constitutes a main surface 10a of cell 10. Anode 13 constitutes a main surface 10b of cell 10. Solid electrolyte layer 11 is disposed between cathode 12 and anode 13. Intermediate layer 14 is disposed between solid electrolyte layer 11 and cathode 12. Solid electrolyte layer 11 and anode 13 are in contact with each other.

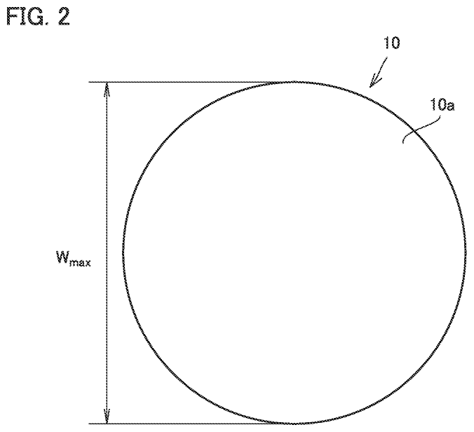

FIG. 2 is a plan view of cell 10. As shown in FIG. 2, cell 10 has a circular shape when viewed in a plan view. However, the planar shape of cell 10 is not limited thereto. Cell 10 may have a quadrangular shape when viewed in a plan view.

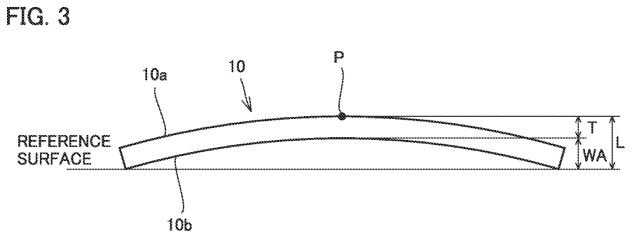

FIG. 3 is a schematic cross sectional view showing a shape of warpage of cell 10. As shown in FIG. 3, cell 10 is warped. For example, cell 10 is warped to protrude from the main surface 10b side toward the main surface 10a side. A warpage amount of cell 10 (hereinafter, referred to as “warpage amount WA”) is, for example, 100 μm or more. Warpage amount WA may be 1000 μm or more.

Warpage amount WA is measured by the following method. First, cell 10 is placed on a flat reference surface. Second, LK-G35 provided by Keyence is used to measure a distance (hereinafter, referred to as “distance L”) between the reference surface and a position (hereinafter, referred to as “apex P”) on main surface 10a with the longest distance from the reference surface. Apex P is located at the central portion of cell 10 (the central portion of main surface 10a) when viewed in a plan view. Third, the thickness of cell 10 (hereinafter, referred to as “thickness T”) is subtracted from distance L. In this way, warpage amount WA is measured.

The maximum width of cell 10 when viewed in a plan view is defined as a width Wₘₐₓ (see FIG. 2). A value obtained by dividing warpage amount WA by width Wₘₐₓ is, for example, 1/1000 or more. The value obtained by dividing warpage amount WA by width Wₘₐₓ may be 1/100 or more. When the planar shape of cell 10 is a circular shape, width Wₘₐₓ is equal to the diameter of the circular shape. When the planar shape of the cell is a quadrangular shape, width Wₘₐₓ is equal to the length of the diagonal of the quadrangular shape.

As shown in FIG. 1A, current collector 20 is disposed on main surface 10a, and current collector 30 is disposed on main surface 10b. From another viewpoint, it can be said that cell 10 is sandwiched between current collector 20 and current collector 30. Current collector 20 is a cathode side current collector, and current collector 30 is an anode side current collector.

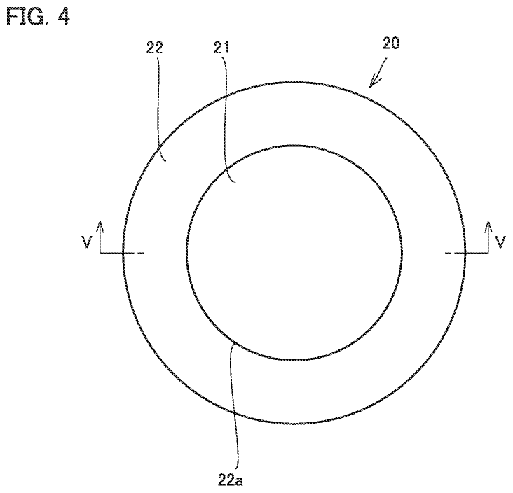

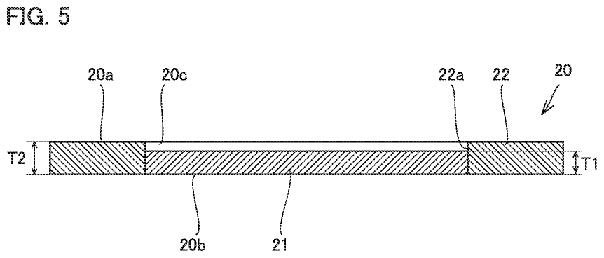

Current collector 20 has a main surface 20a and a main surface 20b. Main surface 20a faces main surface 10a. Main surface 20b is a surface opposite to main surface 20a. FIG. 4 is a plan view of current collector 20. FIG. 5 is a cross sectional view at V-V of FIG. 4. As shown in FIGS. 4 and 5, main surface 20a is provided with recess 20c. Main surface 20a is depressed toward the main surface 20b side in recess 20c. Recess 20c is disposed at a position facing the central portion of main surface 10a.

Current collector 20 is constituted of a metal porous body sheet 21 and a metal porous body sheet 22. Each of metal porous body sheet 21 and metal porous body sheet 22 is composed of a metal porous body having a framework with a three-dimensional network structure.

The framework of the metal porous body of each of metal porous body sheet 21 and metal porous body sheet 22 contains, for example, nickel (Ni) and cobalt. The coating weight of each of metal porous body sheet 21 and metal porous body sheet 22 is preferably 900 g/m² or less. The coating weight of metal porous body sheet 21 (metal porous body sheet 22) is a value obtained by dividing the weight of metal porous body sheet 21 (metal porous body sheet 22) by the area of the main surface of metal porous body sheet 21 (metal porous body sheet 22).

Current collector 20 has a circular shape when viewed in a plan view. Metal porous body sheet 21 has a circular shape when viewed in a plan view. Metal porous body sheet 22 has an annular shape when viewed in a plan view. That is, a through hole 22a is formed in metal porous body sheet 22 so as to extend through metal porous body sheet 22 in the thickness direction of metal porous body sheet 22. Through hole 22a is formed at a position corresponding to recess 20c.

The thickness (hereinafter, referred to as “thickness T2”) of metal porous body sheet 22 is larger than the thickness (hereinafter, referred to as “thickness T1”) of metal porous body sheet 21. Metal porous body sheet 21 and metal porous body sheet 22 are disposed side by side (disposed not to be stacked on each other) in a plane orthogonal to the thickness direction of current collector 20. Metal porous body sheet 21 is disposed in through hole 22a. Therefore, metal porous body sheet 21 and through hole 22a constitute recess 20c.

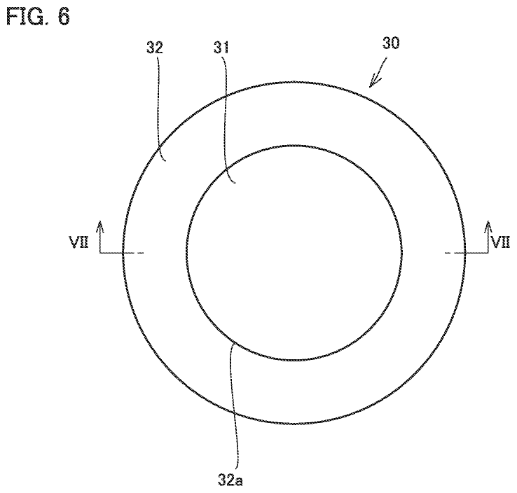

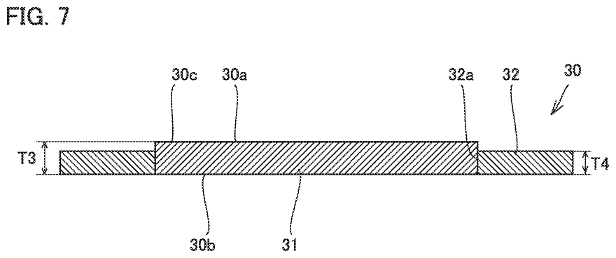

Current collector 30 has a main surface 30a and a main surface 30b. Main surface 30a faces main surface 10b. Main surface 30b is a surface opposite to main surface 30a. FIG. 6 is a plan view of current collector 30. FIG. 7 is a cross sectional view at VII-VII of FIG. 6. As shown in FIGS. 6 and 7, main surface 30a has a protrusion 30c. At protrusion 30c, main surface 30a protrudes opposite to main surface 30b. Protrusion 30c is disposed at a position facing the central portion of main surface 10b.

Current collector 30 is constituted of a metal porous body sheet 31 and a metal porous body sheet 32. Each of metal porous body sheet 31 and metal porous body sheet 32 is constituted of a metal porous body having a framework with a three-dimensional network structure.

The framework of the metal porous body of each of metal porous body sheet 31 and metal porous body sheet 32 contains, for example, nickel. The coating weight of each of metal porous body sheet 31 and metal porous body sheet 32 is preferably 1000 g/m² or less. The coating weight of metal porous body sheet 31 (metal porous body sheet 32) is a value obtained by dividing the weight of metal porous body sheet 31 (metal porous body sheet 32) by the area of the main surface of metal porous body sheet 31 (metal porous body sheet 32).

Current collector 30 has a circular shape when viewed in a plan view. Metal porous body sheet 31 has a circular shape when viewed in a plan view. Metal porous body sheet 32 has an annular shape when viewed in a plan view. That is, a through hole 32a is formed in metal porous body sheet 32 so as to extend through metal porous body sheet 32 in the thickness direction of metal porous body sheet 32. Through hole 32a is formed at a position corresponding to protrusion 30c.

The thickness (hereinafter, referred to as “thickness T3”) of metal porous body sheet 31 is larger than the thickness (hereinafter, referred to as “thickness T4”) of metal porous body sheet 32. Metal porous body sheet 31 and metal porous body sheet 32 are disposed side by side (disposed not to be stacked on each other) in a plane orthogonal to the thickness direction of current collector 30. Metal porous body sheet 31 is disposed in through hole 32a. Therefore, metal porous body sheet 31 constitutes protrusion 30c.

A value obtained by subtracting thickness T1 from thickness T2 is preferably equal to warpage amount WA. A value obtained by subtracting thickness T4 from thickness T3 is preferably equal to warpage amount WA. It should be noted that a case where the value obtained by subtracting thickness T1 from thickness T2 falls within a range of 0.95 time or more and 1.05 times or less as large as warpage amount WA is included in the case where “the value obtained by subtracting thickness T1 from thickness T2 is equal to warpage amount WA”, and a case where the value obtained by subtracting thickness T4 from thickness T3 falls within a range of 0.95 time or more and 1.05 times or less as large as warpage amount WA is included in the case where “the value obtained by subtracting thickness T4 from thickness T3 is equal to warpage amount WA”.

Metal porous body sheet 22 may be concentrically divided into a plurality of metal porous body sheets. In this case, a metal porous body sheet disposed on an outer side is thicker. Metal porous body sheet 32 may be concentrically divided into a plurality of metal porous body sheets. In this case, a metal porous body sheet disposed on an outer side is thinner.

As shown in FIG. 1A, interconnector 40 is disposed on main surface 20b and interconnector 50 is disposed on main surface 30b. From another viewpoint, it can be said that cell 10, current collector 20, and current collector 30 are sandwiched between interconnector 40 and interconnector 50. A groove 41 is formed in the main surface of interconnector 40 on the current collector 20 side, and a groove 51 is formed in the main surface of interconnector 50 on the current collector 30 side. Each of interconnector 40 and interconnector 50 is composed of an electrically conductive material.

Hereinafter, effects of electrochemical cell device 100 will be described.

In electrochemical cell device 100, since cell 10 is warped to protrude from main surface 10b toward main surface 10a, spaces are formed between main surface 10a and main surface 20a and between main surface 10b and main surface 30a when main surface 20a and main surface 30a are flat. This results in an increased contact electrical resistance value between cell 10 and current collector 20, an increased contact electrical resistance value between cell 10 and current collector 30, and a decreased output voltage from electrochemical cell device 100.

However, in electrochemical cell device 100, since main surface 20a is provided with recess 20c and main surface 30a has protrusion 30c, main surface 20a is facilitated to conform to the shape of main surface 10a and main surface 30a is facilitated to conform to the shape of main surface 10b, thereby reducing the spaces between main surface 10a and main surface 20a and between main surface 10b and main surface 30a.

Therefore, according to electrochemical cell device 100, the contact electrical resistance value between cell 10 and current collector 20 and the contact electrical resistance value between cell 10 and current collector 30 can be decreased, and the output voltage from electrochemical cell device 100 can be improved.

It should be noted that when electrochemical cell device 100 is an SOEC, the contact electrical resistance value between cell 10 and current collector 20 and the contact electrical resistance value between cell 10 and current collector 30 are decreased, with the result that the electrolytic voltage in electrochemical cell device 100 can be lowered.

When the framework of the metal porous body of each of metal porous body sheet 21 and metal porous body sheet 22 contains nickel and cobalt and the coating weight of the metal porous body of each of metal porous body sheet 21 and metal porous body sheet 22 is 900 g/m² or less, deformability of each of metal porous body sheet 21 and metal porous body sheet 22 can be ensured, so that main surface 20a is more facilitated to conform to the shape of main surface 10a.

When the framework of the metal porous body of each of metal porous body sheet 31 and metal porous body sheet 32 contains nickel and the coating weight of the metal porous body of each of metal porous body sheet 31 and metal porous body sheet 32 is 900 g/m² or less, deformability of each of metal porous body sheet 31 and metal porous body sheet 32 can be ensured, so that main surface 30a is more facilitated to conform to the shape of main surface 10b.

(Power Generation Test)

Hereinafter, a power generation test performed to confirm the effects of electrochemical cell device 100 will be described.

<Samples>

Electrochemical cells of samples 1 to 6 were provided for a power generation test. In each of samples 1 to 6, the shapes of cell 10, current collector 20, and current collector 30 were as shown in Table 1. It should be noted that although not shown in Table 1, in each of samples 1 to 6, the thickness and diameter of cell 10 were 0.4 mm and 100 mm, respectively.

TABLE 1

| | Warpage | | | |
|---|---|---|---|---|
| | Amount WA | | Current Collector 20 | Current Collector 30 |
| Sample 1 | 100 | μm | Metal Porous Body Sheet 21 | Metal Porous Body Sheet 31 |
| | | | (Thickness T1 = 400 μm) + | (Thickness T3 = 500 μm) + |
| | | | Metal Porous Body Sheet 22 | Metal Porous Body Sheet 32 |
| | | | (Thickness T2 = 500 μm) | (Thickness T4 = 400 μm) |
| Sample 2 | 300 | μm | Metal Porous Body Sheet 21 | Metal Porous Body Sheet 31 |
| | | | (Thickness T1 = 200 μm) + | (Thickness T3 = 500 μm) + |
| | | | Metal Porous Body Sheet 22 | Metal Porous Body Sheet 32 |
| | | | (Thickness T2 = 500 μm) | (Thickness T4 = 200 μm) |
| Sample 3 | 1000 | μm | Metal Porous Body Sheet 21 | Metal Porous Body Sheet 31 |
| | | | (Thickness T1 = 100 μm) + | (Thickness T3 = 1100 μm) + |
| | | | Metal Porous Body Sheet 22 | Metal Porous Body Sheet 32 |
| | | | (Thickness T2 = 1100 μm) | (Thickness T4 = 100 μm) |
| Sample 4 | 2000 | μm | Metal Porous Body Sheet 21 | Metal Porous Body Sheet 31 |
| | | | (Thickness T1 = 100 μm) + | (Thickness T3 = 2100 μm) + |
| | | | Metal Porous Body Sheet 22 | Metal Porous Body Sheet 32 |
| | | | (Thickness T2 = 2100 μm) | (Thickness T4 = 100 μm) |
| Sample 5 | 100 | μm | One Metal Porous Body | One Metal Porous Body |
| | | | Sheet Having Thickness of | Sheet Having Thickness of |
| | | | 500 μm | 500 μm |
| Sample 6 | 1000 | μm | One Metal Porous Body | One Metal Porous Body |
| | | | Sheet Having Thickness of | Sheet Having Thickness of |
| | | | 1100 μm | 1100 μm |

As shown in Table 1, in each of samples 1 and 5, warpage amount WA was 100 μm. In sample 2, warpage amount WA was 300 μm. In each of samples 3 and 6, warpage amount WA was 1000 μm. In sample 4, warpage amount WA was 2000 μm.

In sample 1, a metal porous body sheet 21 having a thickness of 400 μm and a metal porous body sheet 22 having a thickness of 500 μm were used as current collector 20, and a metal porous body sheet 31 having a thickness of 500 μm and a metal porous body sheet 32 having a thickness of 400 μm were used as current collector 30.

In sample 2, a metal porous body sheet 21 having a thickness of 200 μm and a metal porous body sheet 22 having a thickness of 500 μm were used as current collector 20, and a metal porous body sheet 31 having a thickness of 500 μm and a metal porous body sheet 32 having a thickness of 200 μm were used as current collector 30.

In sample 3, a metal porous body sheet 21 having a thickness of 100 μm and a metal porous body sheet 22 having a thickness of 1100 μm were used as current collector 20, and a metal porous body sheet 31 having a thickness of 1100 μm and a metal porous body sheet 32 having a thickness of 100 μm were used as current collector 30.

In sample 4, a metal porous body sheet 21 having a thickness of 100 μm and a metal porous body sheet 22 having a thickness of 2100 μm were used as current collector 20, and a metal porous body sheet 31 having a thickness of 2100 μm and a metal porous body sheet 32 having a thickness of 100 μm were used as current collector 30.

In sample 5, one metal porous body sheet having a thickness of 500 μm was used as current collector 20, and one metal porous body sheet having a thickness of 500 μm was used as current collector 30.

In sample 6, one metal porous body sheet having a thickness of 1100 μm was used as current collector 20, and one metal porous body sheet having a thickness of 1100 μm was used as current collector 30.

<Test Results>

Table 2 shows an initial value of an output voltage between the anode and the cathode when a current of 0.5 A/cm² flows between the anode and the cathode at 750° C.

TABLE 2

| | Output Voltage |
|---|---|
| Sample 1 | 0.85 V |
| Sample 2 | 0.86 V |
| Sample 3 | 0.89 V |
| Sample 4 | 0.90 V |
| Sample 5 | 0.78 V |
| Sample 6 | 0.70 V |

As shown in Table 2, the output voltage of sample 1 was more than the output voltage of sample 5. The output voltage of sample 3 was more than the output voltage of sample 6.

In view of these comparisons, it was also experimentally revealed that since main surface 20a of current collector 20 is provided with recess 20c and main surface 30a of current collector 30 has protrusion 30c, the space between cell 10 and current collector 20 and the space between cell 10 and current collector 30 can be decreased and the output voltage from electrochemical cell device 100 can be increased.

As warpage amount WA is larger, the spaces are more likely to be formed between cell 10 and current collector 20 and between cell 10 and current collector 30, but a surface area of cell 10 contributing to an electrochemical reaction is increased.

The output voltage of sample 6 was less than the output voltage of sample 5. This is presumably due to the following reason: since warpage amount WA of sample 6 was more than warpage amount WA of sample 5, the space between cell 10 and current collector 20 and the space between cell 10 and current collector 30 were increased, thereby increasing the contact electrical resistance between cell 10 and current collector 20 and the contact electrical resistance between cell 10 and current collector 30.

On the other hand, in each of samples 1 to 4, as warpage amount WA was larger, the output voltage was increased. In each of samples 1 to 4, each of the value obtained by subtracting thickness T1 from thickness T2 and the value obtained by subtracting thickness T4 from thickness T3 coincided with warpage amount WA.

In view of this, it was experimentally revealed that by increasing warpage amount WA while each of the value obtained by subtracting thickness T1 from thickness T2 and the value obtained by subtracting thickness T4 from thickness T3 coincides with warpage amount WA, the surface area of cell 10 contributing to the electrochemical reaction can be increased, in other words, the output voltage from electrochemical cell device 100 can be further increased, while reducing the space between cell 10 and current collector 20 and the space between cell 10 and current collector 30.

### Second Embodiment

Hereinafter, a configuration of an electrochemical cell device (hereinafter, referred to as “electrochemical cell device 200”) according to a second embodiment will be described. Here, the following mainly describes differences from the configuration of electrochemical cell device 100, and the same explanation will not be described repeatedly.

Electrochemical cell device 200 includes a cell 10, a current collector 20, a current collector 30, an interconnector 40, and an interconnector 50. Cell 10 is warped to protrude from main surface 10b toward main surface 10a. Main surface 20a is provided with a recess 20c, and main surface 30a has a protrusion 30c. Regarding these points, the configuration of electrochemical cell device 200 is the same as the configuration of electrochemical cell device 100.

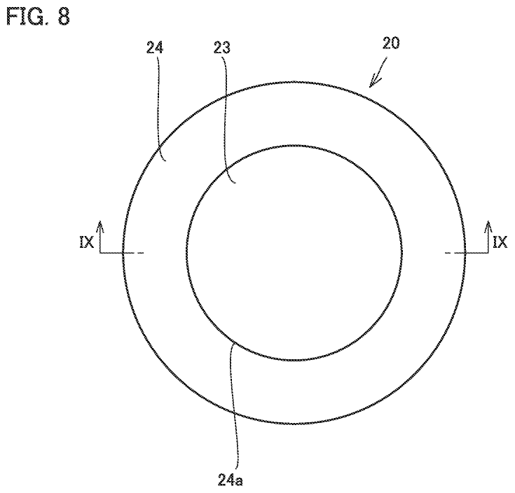

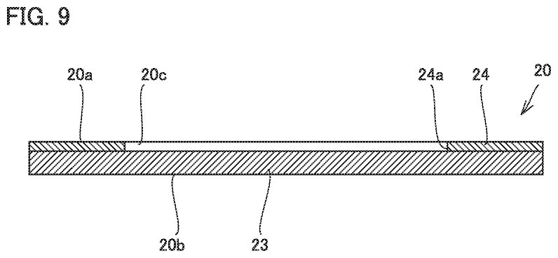

FIG. 8 is a plan view of current collector 20 of electrochemical cell device 200. FIG. 9 is a cross sectional view at IX-IX of FIG. 8. As shown in FIGS. 8 and 9, in electrochemical cell device 200, current collector 20 has a metal porous body sheet 23 and a metal porous body sheet 24. Metal porous body sheet 23 has a circular shape when viewed in a plan view, for example. Metal porous body sheet 24 has an annular shape when viewed in a plan view, for example.

A through hole 24a is formed in metal porous body sheet 24 so as to extend through metal porous body sheet 24 in the thickness direction of metal porous body sheet 24. Through hole 24a is disposed at a position corresponding to recess 20c. Metal porous body sheet 23 and metal porous body sheet 24 are disposed to be stacked on each other in the thickness direction of current collector 20. Metal porous body sheet 24 is disposed on the main surface 20a side. As a result, through hole 24a and metal porous body sheet 23 constitute recess 20c.

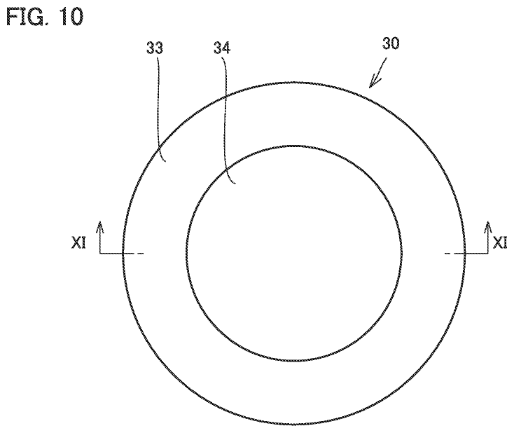

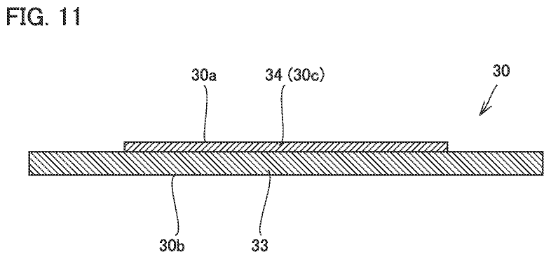

FIG. 10 is a plan view of current collector 30 of electrochemical cell device 200. FIG. 11 is a cross sectional view at XI-XI of FIG. 10. As shown in FIGS. 10 and 11, current collector 30 has a metal porous body sheet 33 and a metal porous body sheet 34. Each of metal porous body sheet 33 and metal porous body sheet 34 has a circular shape when viewed in a plan view, for example. The diameter of metal porous body sheet 33 is larger than the diameter of metal porous body sheet 34.

Metal porous body sheet 33 and metal porous body sheet 34 are stacked on each other in the thickness direction of current collector 30. Metal porous body sheet 34 is disposed on the main surface 30a side so as to correspond to the position of protrusion 30c. As a result, metal porous body sheet 34 constitutes protrusion 30c.

Hereinafter, effects of electrochemical cell device 200 will be described.

As with electrochemical cell device 100, since main surface 20a is provided with recess 20c and main surface 30a has protrusion 30c in electrochemical cell device 200, main surface 20a is facilitated to conform to the shape of main surface 10a and main surface 30a is facilitated to conform to the shape of main surface 10b, thereby reducing the spaces between main surface 10a and main surface 20a and between main surface 10b and main surface 30a. As a result, according to electrochemical cell device 200, the contact electrical resistance value between cell 10 and current collector 20 and the contact electrical resistance value between cell 10 and current collector 30 can be decreased, and the output voltage from electrochemical cell device 100 can be improved.

### Third Embodiment

Hereinafter, a configuration of an electrochemical cell device (hereinafter, referred to as “electrochemical cell device 300”) according to a third embodiment will be described. Here, the following mainly describes differences from the configuration of electrochemical cell device 100, and the same explanation will not be described repeatedly.

Electrochemical cell device 300 includes a cell 10, a current collector 20, a current collector 30, an interconnector 40, and an interconnector 50. Cell 10 is warped to protrude from main surface 10b toward main surface 10a. Main surface 20a is provided with a recess 20c, and main surface 30a has a protrusion 30c. Regarding these points, the configuration of electrochemical cell device 300 is the same as the configuration of electrochemical cell device 100.

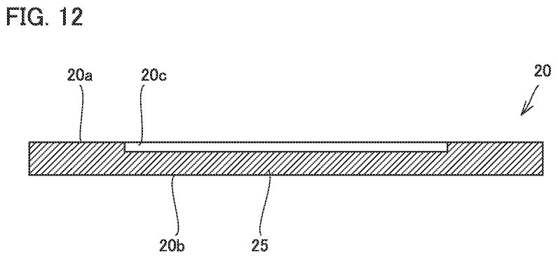

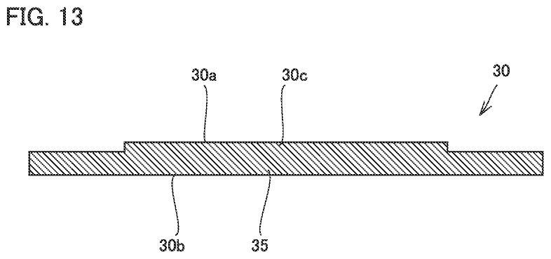

FIG. 12 is a cross sectional view of current collector 20 of electrochemical cell device 300. FIG. 13 is a cross sectional view of current collector 30 of electrochemical cell device 300. As shown in FIGS. 12 and 13, each of current collector 20 and current collector 30 is constituted of one metal porous body sheet (metal porous body sheet 25 and metal porous body sheet 35).

It should be noted that each of recess 20c of current collector 20 (metal porous body sheet 25) and protrusion 30c of current collector 30 (metal porous body sheet 35) can be formed by, for example, press working.

Hereinafter, effects of electrochemical cell device 300 will be described.

As with electrochemical cell device 100, since main surface 20a is provided with recess 20c and main surface 30a has protrusion 30c in electrochemical cell device 300, main surface 20a is facilitated to conform to the shape of main surface 10a and main surface 30a is facilitated to conform to the shape of main surface 10b, thereby reducing the spaces between main surface 10a and main surface 20a and between main surface 10b and main surface 30a. As a result, according to electrochemical cell device 300, the contact electrical resistance value between cell 10 and current collector 20 and the contact electrical resistance value between cell 10 and current collector 30 are decreased, and the output voltage from electrochemical cell device 100 can be improved.

The embodiments disclosed herein are illustrative and non-restrictive in any respect. The scope of the present invention is defined by the terms of the claims, rather than the embodiments described above, and is intended to include any modifications within the scope and meaning equivalent to the terms of the claims.

### REFERENCE SIGNS LIST

10: cell; 10a, 10b: main surface; 11: solid electrolyte layer; 12: cathode; 13: anode; 14: intermediate layer; 20: current collector; 20a, 20b: main surface; 20c: recess; 21: metal porous body sheet; 22: metal porous body sheet; 22a: through hole; 23: metal porous body sheet; 24: metal porous body sheet; 24a: through hole; 25: metal porous body sheet; 30: current collector; 30a: main surface; 30b: main surface; 30c: protrusion; 31: metal porous body sheet; 32: metal porous body sheet; 32a: through hole; 33, 34, 35: metal porous body sheet; 40: interconnector; 41: groove; 50: interconnector; 51: groove; 100, 200, 300: electrochemical cell device; L: distance; P: apex; T, T1, T2, T3, T4: thickness; WA: warpage amount; Wₘₐₓ: width.

1. A electrochemical cell device comprising:
a cell having a first main surface and a second main surface opposite to the first main surface;
a first current collector having a third main surface facing the first main surface; and
a second current collector having a fourth main surface facing the second main surface, wherein
the cell is warped to protrude from the second main surface toward the first main surface,
the third main surface is provided with a recess at a position facing a central portion of the first main surface,
the fourth main surface includes a protrusion at a position facing a central portion of the second main surface,
each of the first current collector and the second current collector is constituted of one or more metal porous body sheets each composed of a metal porous body having a framework with a three-dimensional network structure,
the central portion of the first main surface includes a portion of the first main surface with a longest distance from a flat reference surface when the cell is placed on the reference surface such that the second main surface faces the reference surface, and
the central portion of the second main surface includes a portion of the second main surface with a longest distance from the reference surface when the cell is disposed on the reference surface such that the second main surface faces the reference surface.

2. The electrochemical cell device according to claim 1, wherein
the one or more metal porous body sheets of the first current collector are a first metal porous body sheet and a second metal porous body sheet,
the first metal porous body sheet and the second metal porous body sheet are disposed side by side in a plane orthogonal to a thickness direction of the first current collector,
a first through hole is formed in the second metal porous body sheet at a position corresponding to the recess so as to extend through the second metal porous body sheet in a thickness direction of the second metal porous body sheet,
the first metal porous body sheet is disposed in the first through hole,
a thickness of the second metal porous body sheet is more than a thickness of the first metal porous body sheet, and
the recess is defined by an inner peripheral surface of the first through hole and a main surface of the first metal porous body sheet.

3. The electrochemical cell device according to claim 2, wherein a value obtained by subtracting the thickness of the first metal porous body sheet from the thickness of the second metal porous body sheet is equal to a warpage amount of the cell.

4. The electrochemical cell device according to claim 1, wherein
the one or more metal porous body sheets of the first current collector are a first metal porous body sheet and a second metal porous body sheet,
the first metal porous body sheet and the second metal porous body sheet are disposed to be stacked on each other such that the second metal porous body sheet is located on the third main surface side in a thickness direction of the first current collector, and
a first through hole is formed in the second metal porous body sheet at a position corresponding to the recess so as to extend through the second metal porous body sheet in a thickness direction of the second metal porous body sheet.

5. The electrochemical cell device according claim 1, wherein
the one or more metal porous body sheets of the second current collector are a third metal porous body sheet and a fourth metal porous body sheet,
the third metal porous body sheet and the fourth metal porous body sheet are disposed side by side in a plane orthogonal to a thickness direction of the second current collector,
a second through hole is formed in the fourth metal porous body sheet at a position corresponding to the protrusion so as to extend through the fourth metal porous body sheet in a thickness direction of the fourth metal porous body sheet,
the third metal porous body sheet is disposed in the second through hole, and
a thickness of the third metal porous body sheet is more than a thickness of the fourth metal porous body sheet.

6. The electrochemical cell device according to claim 5, wherein a value obtained by subtracting the thickness of the fourth metal porous body sheet from the thickness of the third metal porous body sheet is equal to a warpage amount of the cell.

7. The electrochemical cell device according to claim 1, wherein
the one or more metal porous body sheets of the second current collector are a third metal porous body sheet and a fourth metal porous body sheet,
the third metal porous body sheet and the fourth metal porous body sheet are disposed to be stacked on each other such that the fourth metal porous body sheet is located on the fourth main surface side in a thickness direction of the second current collector, and
the fourth metal porous body sheet constitutes the protrusion.

8. The electrochemical cell device according to claim 1, wherein
the first current collector is a cathode side current collector, and
the second current collector is an anode side current collector.

9. The electrochemical cell device according to claim 8, wherein
the framework of each of the one or more metal porous body sheets of the first current collector contains nickel and cobalt, and
a coating weight of each of the one or more metal porous body sheets of the first current collector is 900 g/m² or less.

10. The electrochemical cell device according to claim 8, wherein
the framework of each of the one or more metal porous body sheets of the second current collector contains nickel, and
a coating weight of each of the one or more metal porous body sheets of the second current collector is 1000 g/m² or less.

11. The electrochemical cell device according to claim 1, wherein a value obtained by dividing a warpage amount of the cell by a maximum width of the cell when viewed in a plan view is 1/1000 or more.

12. The electrochemical cell device according to claim 1, wherein the electrochemical cell device is a solid oxide fuel cell.

13. The electrochemical cell device according to claim 1, wherein the electrochemical cell device is a solid oxide electrolysis cell.
